(19) United States
(12) Patent Application Publication
(10) Pub. No.: US 2024/0317174 A1
(43) Pub. Date: Sep. 26, 2024

(54) Device and System for Item Storage and Retrieval by Delivery Robots

(71) Applicants: Andres Felipe Chavez Cortes, El Cerrito, CA (US); Leonardo Andrés Correa Romero, Medellín (CO); Andres Felipe Rengifo Sanchez, Medellín (CO); Jose Alejandro Logreira Avila, Envigado (CO)

(72) Inventors: Andres Felipe Chavez Cortes, El Cerrito, CA (US); Leonardo Andrés Correa Romero, Medellín (CO); Andres Felipe Rengifo Sanchez, Medellín (CO); Jose Alejandro Logreira Avila, Envigado (CO)

(21) Appl. No.: 18/615,589

(22) Filed: Mar. 25, 2024

Related U.S. Application Data
(60) Provisional application No. 63/492,151, filed on Mar. 24, 2023.

(51) Int. Cl. B60R 25/01; B60P 3/00; B60R 16/03; B60R 25/20; B60R 25/40

(52) U.S. Cl. CPC B60R 25/01; B60P 3/007; B60R 16/03; B60R 25/20; B60R 25/403

(57) ABSTRACT

The present invention relates to an item compartment system for mobile robots designed to conduct last-mile deliveries. More specifically, the invention relates to a system integrated into the structure of the mobile robot, secured by a lock, designed to automatically open and close the lid of the robot in order to facilitate the reception and delivery of items from retailers to customers.

### FIELD OF THE INVENTION

The present invention relates to an item compartment system for mobile robots designed to conduct last-mile deliveries. More specifically, the invention relates to an apparatus integrated into the structure of the mobile robot, secured by a lock, designed to automatically open and close the lid of the robot in order to facilitate the reception and delivery of items from retailers to customers.

### BACKGROUND OF THE INVENTION

Automation of commercial tasks is rapidly changing many industries across the world. Among the many industries where automation is on the rise, logistics represents the sector with the fastest adoption of robotic solutions for automation of tasks.

One of the main components of the delivery industry is the last-mile delivery of consumable items. Last-mile deliveries are a key part of the logistics industry. Delivery of goods has traditionally been done by a human courier mobilized by a manned vehicle. However, concerns regarding carbon emissions, increased traffic and rising labor costs have raised doubts from stakeholders on the long-term viability of conventional delivery methods.

Both ground and aerial unmanned systems are being used for last-mile deliveries, but aerial systems have been largely excluded from this technological revolution due to security concerns and restrictive regulations. This setting makes ground mobile robots the ideal unmanned solution for the delivery of items from businesses, such as retailers and restaurants, to customers.

These mobile robots are released under small and medium designs with the purpose of enabling their use in public sidewalks, preventing an increase in traffic in urban areas. Moreover, mobile robots from certain companies are also operating on the streets, albeit in sizes that still contribute to a reduction of traffic in urban areas when compared to the size of conventional transport methods. These systems may navigate autonomously and/or semi-autonomously with the help of a computer vision system based on the use of several sensors and sophisticated algorithms for analysis of the environment.

It is within this context that the storage of items onto the robotic platform comes into relevance. Ground mobile robots must count with a system capable of enabling the storage of items into the robot, as well as to enable the reception of the item by customers. Moreover, this system must also ensure the safety of the item along the route the mobile robot must traverse.

The present invention provides a solution to this concern by providing mobile robots with a system capable of manually and/or automatically opening the lid of the cabin of the mobile robot when it has reached the item retrieval point and the pick-up point defined by the customer. This system may be activated manually by a remote operator or automatically upon reaching the business where it must retrieve the items and the pick-up point defined by the customer during the order process. Furthermore, the present system includes a lock apparatus designed to ensure the safety of the items during navigation by preventing third parties from forcing the opening of the cabin of the mobile robot.

### SUMMARY OF THE INVENTION

Given the developments highlighted beforehand, it is the object of the present invention to provide developers of ground-based robotic platforms with a system capable of opening the lid of the mobile robot manually by a teleoperator and/or automatically upon reaching an item retrieval or delivery point. The present invention is specified in the claims as well as in the below description. Preferred embodiments are particularly specified in the dependent claims and the description of various embodiments.

### BRIEF DESCRIPTION OF THE DRAWINGS

FIG. 1 is a view of a complete embodiment of the invention.

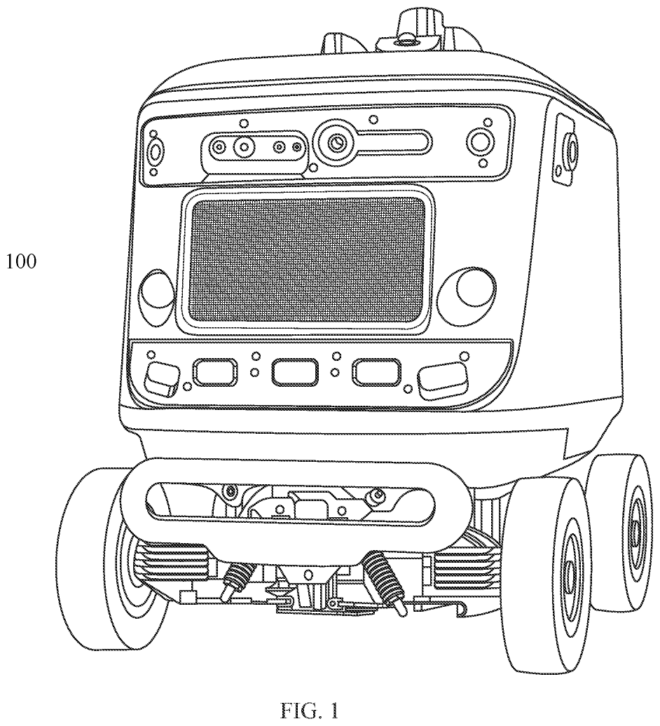

FIG. 2a is a front view of a main cabinet for the robotic platform's position within an embodiment.

FIG. 2b is a side view of a main cabinet for the robotic platform's position within an embodiment.

FIG. 3 shows the upper lid to the robot's storage area in an embodiment.

FIG. 4 is a component breakdown for an embodiment of the mechanism operating the lid.

FIG. 4a is a detail view of a hinge sub-assembly for this embodiment.

FIG. 4b is an assembled view of the lid operating mechanism for this embodiment.

FIG. 4c is an assembled, rear-facing view of the lid operating mechanism for this embodiment.

FIG. 5 displays an embodiment of the mounting assembly for the lid operating mechanism.

FIG. 6 demonstrates the locking mechanism for an embodiment.

### DETAIL DESCRIPTIONS OF THE INVENTION

All illustrations of the drawings are for the purpose of describing selected versions of the present invention and are not intended to limit the scope of the present invention.

The present invention relates to an item compartment system for mobile robots designed to conduct last-mile deliveries. It may be referred to in this description as the “System for Item Storage and Retrieval for Mobile Robots Designed for Last-Mile Deliveries” or the “Delivery Robot.” In the context of this invention, the term “robot” specifies an autonomous, mobile, and mechanical object equipped with human accessible storage space. However, embodiments of the invention could be installed within remotely controlled drones or other human-operated vehicles.

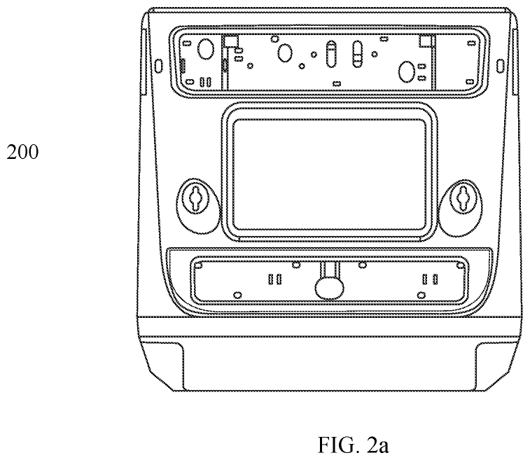

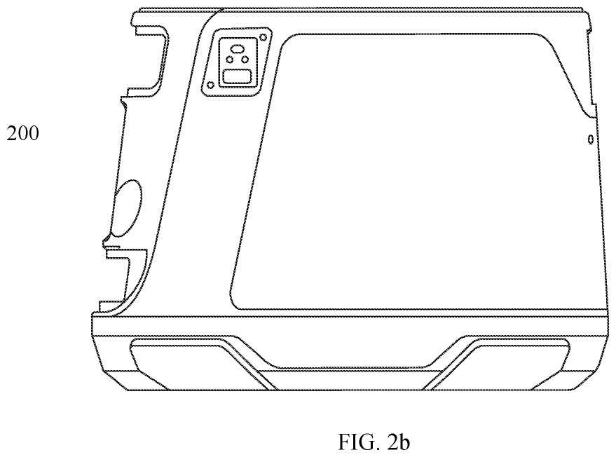

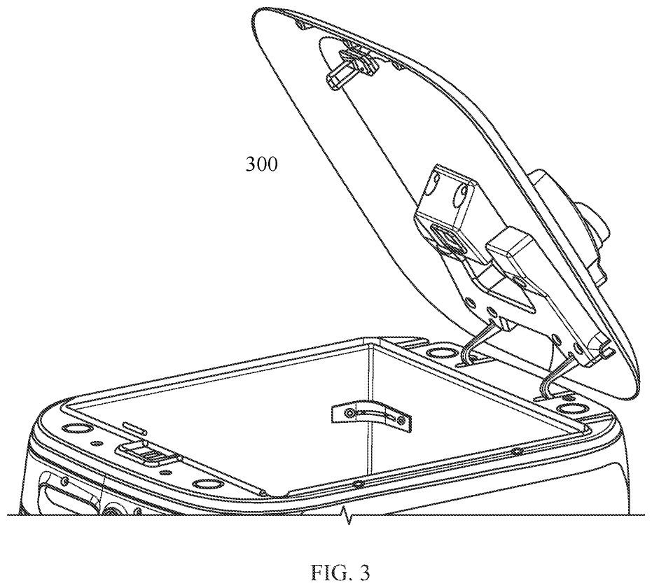

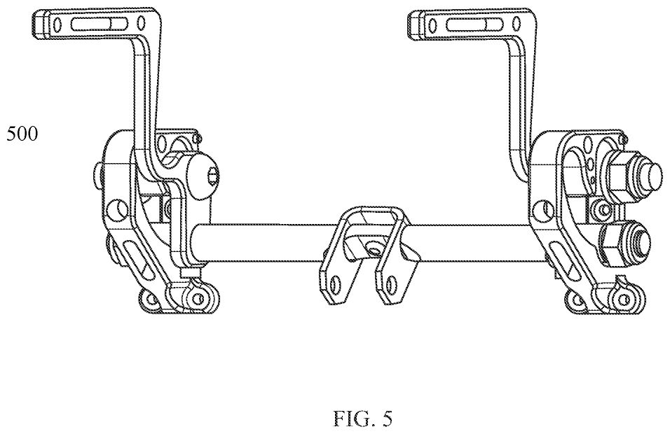

The invention discloses an apparatus for closing and locking the lid of a ground mobile robot designed for last-mile deliveries (100) as a preferred embodiment. The invention may enable these actions to be performed manually or automatically. FIG. 5 depicts a complete embodiment of the invention's lid mounting assembly (500). The assembly connects the cabin of the mobile robot (200) displayed in FIG. 2 to the lid from FIG. 3 (300) for this embodiment of the invention. This has an actuator (410) that is attached to a lower bracket at the base of the cabin (412) and an upper bracket (414) on the mounting assembly (500). The actuator (410) is powered through the robot's power system and provides vertical linear movement to the lid operating mechanism (400).

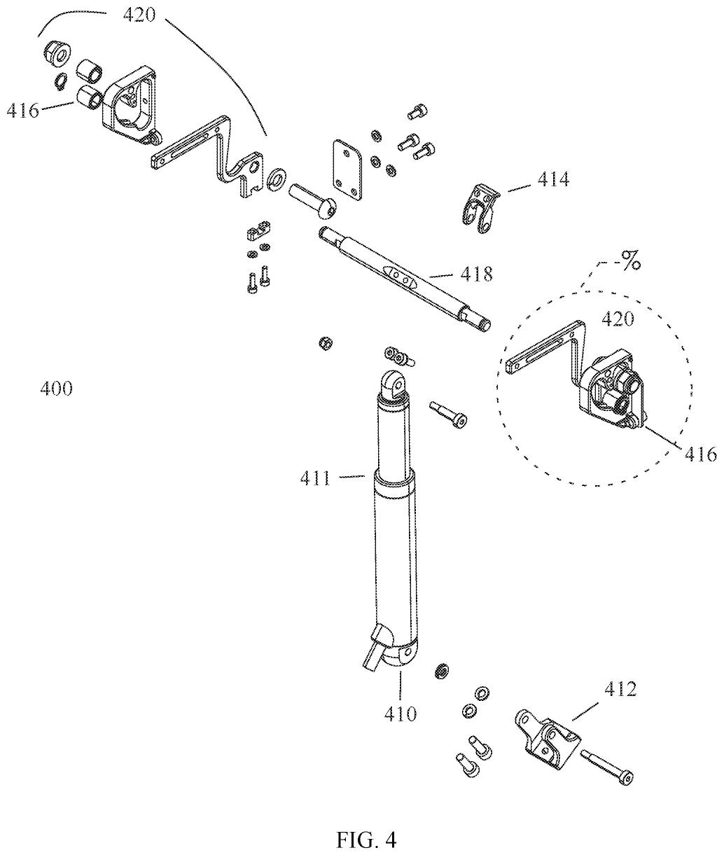

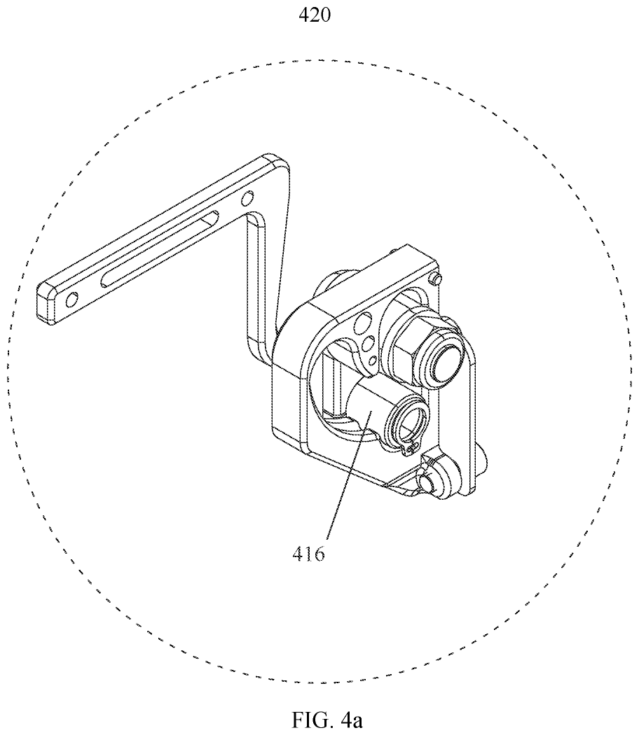

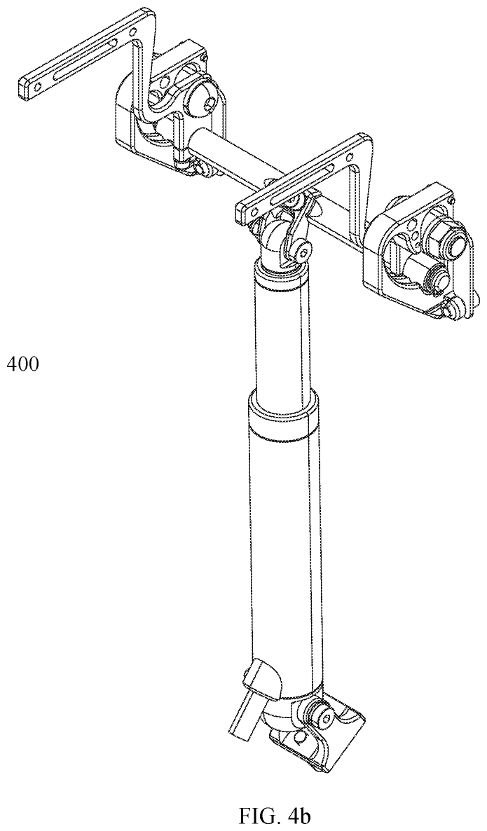

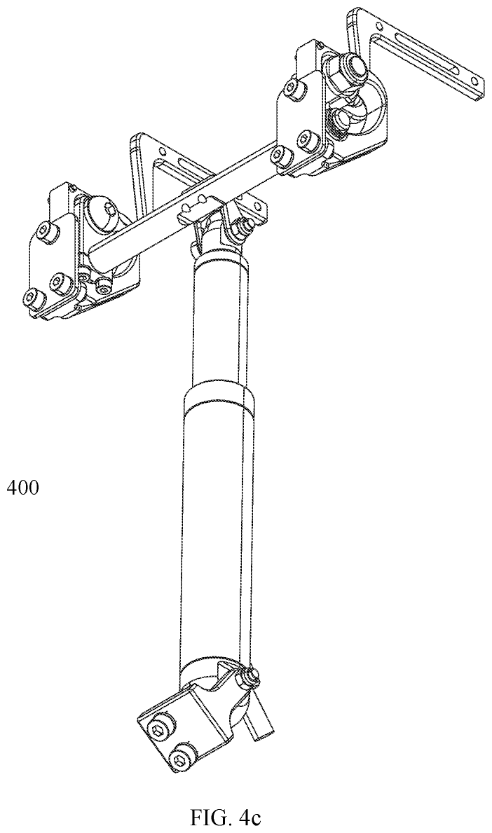

For enabling the actuator (410) to function, a mounting bracket (412) within the cabin is attached to the actuator (410) and to the mounting assembly by another mounting bracket (414) to its external side to the shaft. The actuator (410) includes a vertically aligned mobile shaft (411) which is attached to the lower mounting bracket (412) and transversally to the mounting assembly (500) at its middle point through the upper bracket (414). The mounting assembly (500) includes the upper mounting bracket (414), two bearings (416) embedded in a horizontal shaft (418), and two hinge guide assemblies (420) connected to the horizontal shaft (418) by the bearings (416). These two bearings (416) at the ends of the mounting assembly (500) transform the vertical, linear movement of the actuator (410) to a circular motion bound by the hinge guides (420). The assembly and its components are depicted in FIG. 4.

The circular movement enabled by the bearings (416), requires that the hinge guides (420) be attached to the interior cabin (200) and the lid (300). Specifically, the hinge guides (420) are attached to the lid (300), the horizontal shaft (418), and the cabin's side along the upper edge of the cabin's compartment. The actuator (410) moves vertically, rotating the horizontal shaft (418) in the mounting assembly (500). The ration translates through the connected bearings (416) to the hinge assemblies (420), opening the lid (300) at that point. This circular movement of the shaft operates the opening and closing motion of the lid (300). The described embodiment of mounting assembly (500) is depicted in assembled state by FIG. 5.

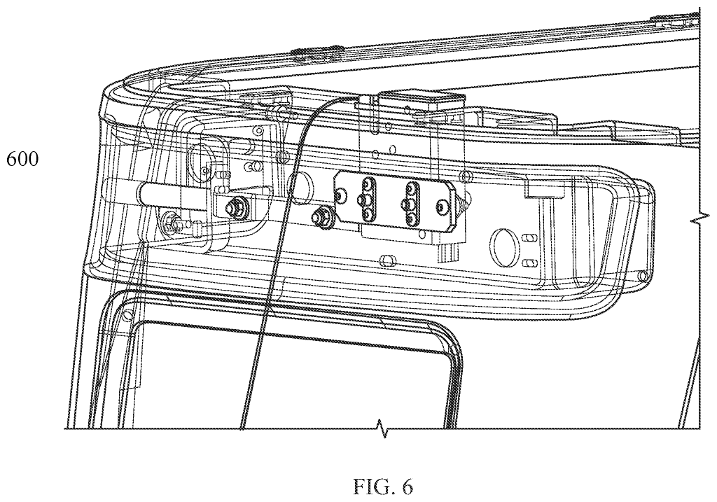

The present system also includes a lock mechanism (600). A latch on the lid (300) secures closure of the robot's compartment. The lock mechanism (600) is attached to the lid (300) via the latch and embedded within the cabin (200) to resist forceful intrusion while closed. An embodiment of the locking mechanism is shown in FIG. 6.

Although the invention has been explained in relation to its preferred embodiment, it is to be understood that many other possible modifications and variations can be made without departing from the spirit and scope of the invention.

1. An apparatus designed to operate the storage lid of a delivery robot comprising:
a robot comprising:
a mobile structure; and
a power system;
a storage cabin comprising:
a lid; and
three or more walls enclosed around a storage space;
an actuator assembly comprising:
an actuator;
a vertical shaft embedded within the actuator; and
a lower mounting bracket; wherein
the lower mounting bracket is connected to the actuator; and
engaging the actuator moves provides vertical motion of the vertical shaft;
a mounting assembly comprising:
a horizontal shaft;
an upper mounting bracket;
two bearings embedded in the ends of the horizontal shaft; and
two hinge guide sub-assemblies attached to the bearings; wherein
the upper mounting bracket is connected to the center of horizontal shaft; and
wherein
the storage cabin is attached to the mobile structure of the robot;
the robot's power system is connected to the actuator assembly as a power source;
the actuator assembly is attached to the lower interior of the storage cabin by its lower mounting bracket;
the vertical shaft of the actuator assembly is attached to the upper mounting bracket of the mounting assembly such that its vertical motion rotates the horizontal shaft along an axis bound by the hinge guides;
the hinge guides are connected to the underside of the storage cabin's lid and the interior cabin walls such that the rotation of the horizontal shaft will open or close the lid.

2. The apparatus of claim 1, further comprising a locking mechanism wherein the locking mechanism is attached to the cabin and its lid opposite the mounting assembly and the locking mechanism is configured to allow it to be engaged when the lid is closed.

3. The apparatus of claim 2, wherein the locking mechanism is electronic and is connected to the power system of the robot.

4. The apparatus of claim 2, further comprising an independent power source, wherein the locking mechanism is electronic and is connected to the independent power source.

5. The apparatus of claim 2, wherein the locking mechanism is accessed by a code.

6. The apparatus of claim 2, wherein the locking mechanism is controlled remotely.

7. The apparatus of claim 1, wherein the robot's power system is connected to the actuator by an electronic control board.

8. The apparatus of claim 7, wherein the electronic control board is mounted in the aft portion of the robot's mobile structure.

9. An apparatus designed to operate the storage lid of a delivery drone comprising:
a drone comprising:
a mobile structure; and
a power system;
a storage cabin comprising:
a lid; and
three or more walls enclosed around a storage space;
an actuator assembly comprising:
an actuator;
a vertical shaft embedded within the actuator; and
a lower mounting bracket; wherein
the lower mounting bracket is connected to the actuator; and
engaging the actuator moves provides vertical motion of the vertical shaft;
a mounting assembly comprising:
a horizontal shaft;
an upper mounting bracket;
two bearings embedded in the ends of the horizontal shaft; and
two hinge guide sub-assemblies attached to the bearings; wherein
the upper mounting bracket is connected to the center of horizontal shaft; and
wherein
the storage cabin is attached to the mobile structure of the drone;
the drone's power system is connected to the actuator assembly as a power source;
the actuator assembly is attached to the lower interior of the storage cabin by its lower mounting bracket;
the vertical shaft of the actuator assembly is attached to the upper mounting bracket of the mounting assembly such that its vertical motion rotates the horizontal shaft along an axis bound by the hinge guides;
the hinge guides are connected to the underside of the storage cabin's lid and the interior cabin walls such that the rotation of the horizontal shaft will open or close the lid.

10. The apparatus of claim 9, further comprising a locking mechanism wherein the locking mechanism is attached to the cabin and its lid opposite the mounting assembly and the locking mechanism is configured to allow it to be engaged when the lid is closed.

11. The apparatus of claim 10, wherein the locking mechanism is electronic and is connected to the power system of the drone.

12. The apparatus of claim 10, further comprising an independent power source, wherein the locking mechanism is electronic and is connected to the independent power source.

13. The apparatus of claim 10, wherein the locking mechanism is accessed by a code.

14. The apparatus of claim 10, wherein the locking mechanism is controlled remotely.

15. The apparatus of claim 9, wherein the robot's power system is connected to the actuator by an electronic control board.

16. The apparatus of claim 15, wherein the electronic control board is mounted in the aft portion of the drone's mobile structure.
